(19) United States
(12) Patent Application Publication
(10) Pub. No.: US 2008/0211289 A1
(43) Pub. Date: Sep. 4, 2008

(54) Self-Propelled Trailer

(76) Inventors: Aaron Beiler, Gap, PA (US); Raymond Beiler, Gap, PA (US)

Correspondence Address: BARLEY SNYDER, LLC, 1000 WESTLAKES DRIVE, SUITE 275, BERWYN, PA, 19312, US

(21) Appl. No.: 12/039,454

(22) Filed: Feb. 28, 2008

Related U.S. Application Data
(60) Provisional application No. 60/892,454, filed on Mar. 1, 2007.

(51) Int. Cl. B60P 1/43; B60P 1/28; B60D 1/155

(52) U.S. Cl. 298/19 R; 414/381; 280/482

(57) ABSTRACT

A trailer having a support frame supported by at least two drive wheels, a drive system configured to selectively rotate the at least two drive wheels, a dump frame associated with the support frame and pivotable with respect to the support frame, a steering system having at least one steerable wheel located forward of the at least two drive wheels, and an extendable tail carried by the dump frame, the extendable tail being selectively extendable from a rear of the dump frame is disclosed.

### CROSS-REFERENCE TO RELATED APPLICATION DATA

This application claims the benefit of the earlier filed U.S. Provisional Patent Application No. 60/892,454 that has a filing date of Mar. 1, 2007.

### FIELD OF THE INVENTION

The present invention relates generally to the field of trailers and more particularly to the field of self-propelled trailers.

### BACKGROUND

Large loads such as storage sheds are often transported from a display or manufacture site to the delivery location using trailers. However, conventional trailers are not well equipped for loading and unloading the large loads. Further, conventional trailers that are capable of carrying such large loads are often too large and/or heavy to navigate from the street near the delivery site to the final delivery location. These problems often lead to less than optimal shed delivery and even cause customers to forego the purchase of such a large shed since they will be unable to have the load delivered to their desired delivery location. Further, for those customers who are able to have the load delivered to their desired delivery location, the yard or landscaping of the delivery location is often damaged due to the excessive weight of the vehicle that tows the trailer.

### SUMMARY

The present invention, in one embodiment among others, relates to trailer having a support frame supported by at least two drive wheels, a drive system configured to selectively rotate the at least two drive wheels, a dump frame associated with the support frame and pivotable with respect to the support frame, a steering system having at least one steerable wheel located forward of the at least two drive wheels, and an extendable tail carried by the dump frame, the extendable tail being selectively extendable from a rear of the dump frame.

### BRIEF DESCRIPTION OF THE DRAWINGS

FIG. 1 is an oblique view of a trailer according to the present invention;

FIG. 2 is an oblique view showing the trailer of FIG. 1 in a dump configuration;

FIG. 3 is an orthogonal side view showing the trailer of FIG. 1 in a dump configuration;

FIG. 4 is an oblique view showing the trailer of FIG. 1 in an extended configuration;

FIG. 5 is an orthogonal top view showing the trailer of FIG. 1 in an extended configuration;

FIG. 6 is an oblique view of a portion of the trailer of FIG. 1;

FIG. 7 is an orthogonal side view of a portion of the trailer of FIG. 1;

FIG. 8 is an orthogonal top view of a portion of the trailer of FIG. 1, showing various positions of a shiftable ramp of the trailer of FIG. 1;

FIG. 9 is an orthogonal bottom view of a portion of the trailer of FIG. 1, showing the shiftable ramp of the trailer of FIG. 1;

FIG. 10 is an oblique view of a steering system of the trailer of FIG. 1;

FIG. 11 is an oblique view of a steering system lock of the trailer of FIG. 1;

FIG. 12 is a partial cross-sectional view of the trailer of FIG. 1, showing the steering system and a transmission engagement lever of the trailer of FIG. 1 and showing the steering system in a lowered configuration;

FIG. 13 is a partial cross-sectional view of the trailer of FIG. 1, showing the steering system and a transmission activation arm of the trailer of FIG. 1 and showing the steering system in a retracted configuration;

FIG. 14 is a cross-sectional view of a drive system of the trailer of FIG. 1, showing the drive system in a disengaged configuration;

FIG. 15 is a partial orthogonal top view of the trailer of FIG. 1, showing the drive system;

FIG. 16 is an oblique partial view of the drive system of the trailer of FIG. 1;

FIG. 17 is an oblique partial exploded view of the drive system of the trailer of FIG. 1;

FIG. 18 is an oblique partial view of the trailer of FIG. 1, showing the pop-up load spinner in an extended configuration;

FIG. 19 is a simplified schematic of a power and control system of the trailer of FIG. 1; and

FIG. 20 is an orthogonal front view of a wireless remote controller of the trailer of FIG. 1.

### DETAILED DESCRIPTION OF THE EMBODIMENTS

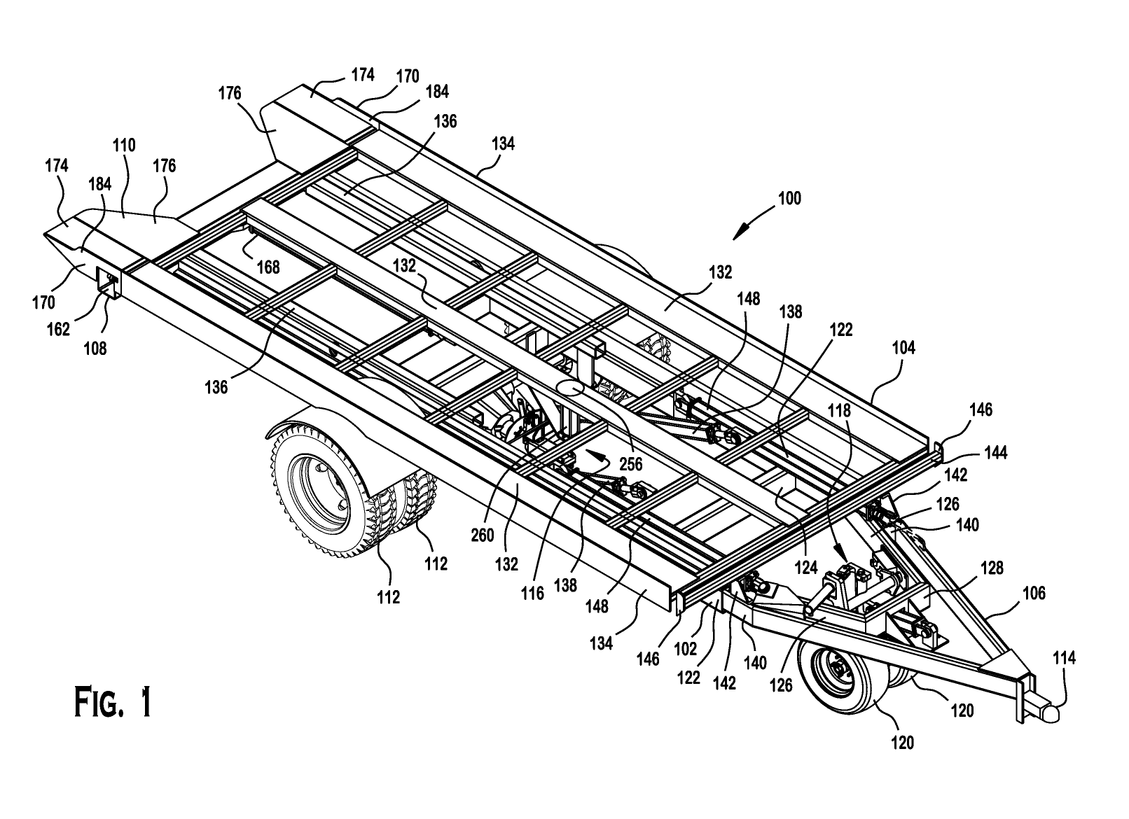

Referring to FIGS. 1-5, an embodiment of a trailer according to the present invention is illustrated. The trailer 100 generally comprises a support frame 102, a dump frame 104 pivotally attached to the support frame 102, an extendable tongue 106 attached to a front of the support frame 102, and an extendable tail 108 attached to a rear end of the dump frame 104. A selectively shiftable ramp 110 is movably attached to a rear end of the extendable tail 108. The trailer 100 further comprises road wheels 112 suitable for supporting the trailer 100 and a load carried by the trailer 100. In this embodiment, the trailer 100 comprises four road wheels 112. A trailer coupler 114 is carried by the extendable tongue 106 at a front of the extendable tongue 106 and is well suited for being selectively associated with a towing vehicle (not shown). Trailer 100 further generally comprises a drive system 116 for selectively driving road wheels 112 and a retractable steering system 118 for controlling and retracting steering wheels 120.

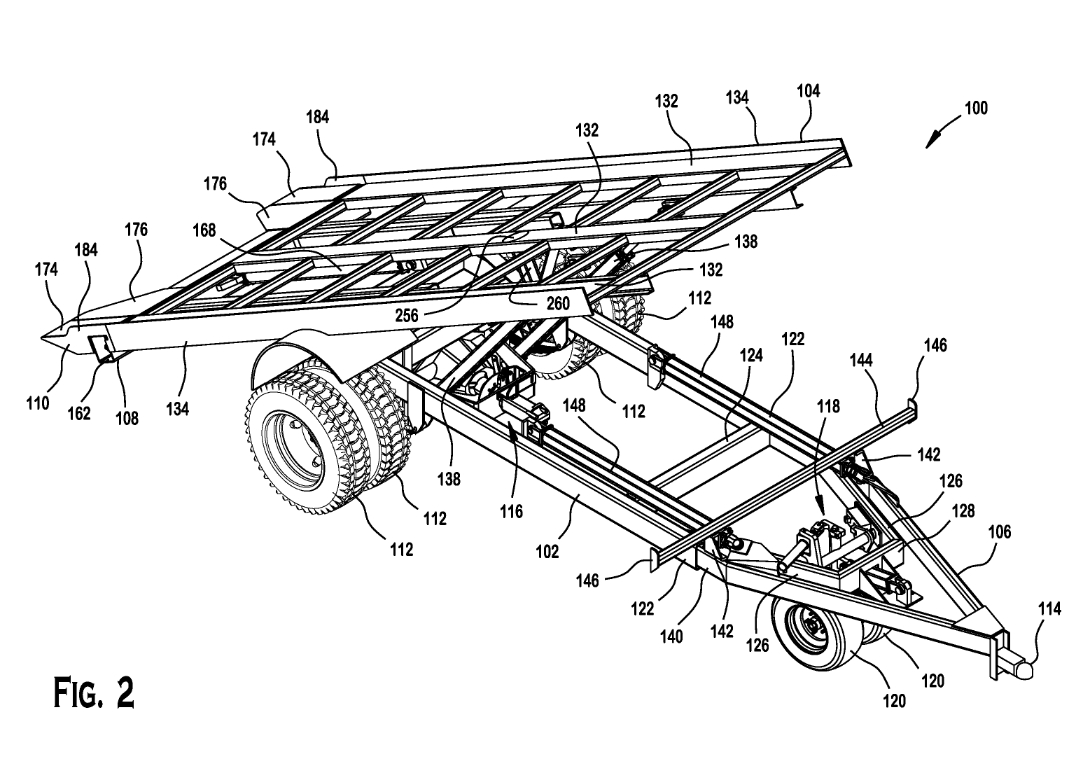

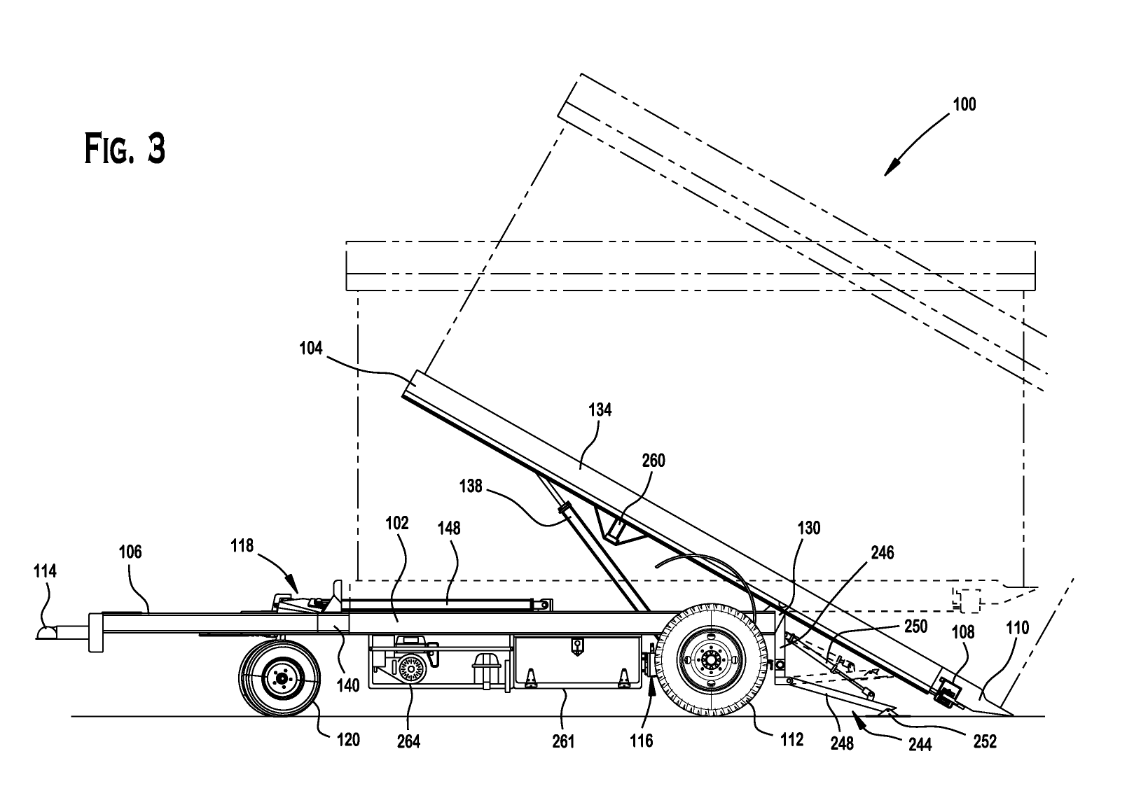

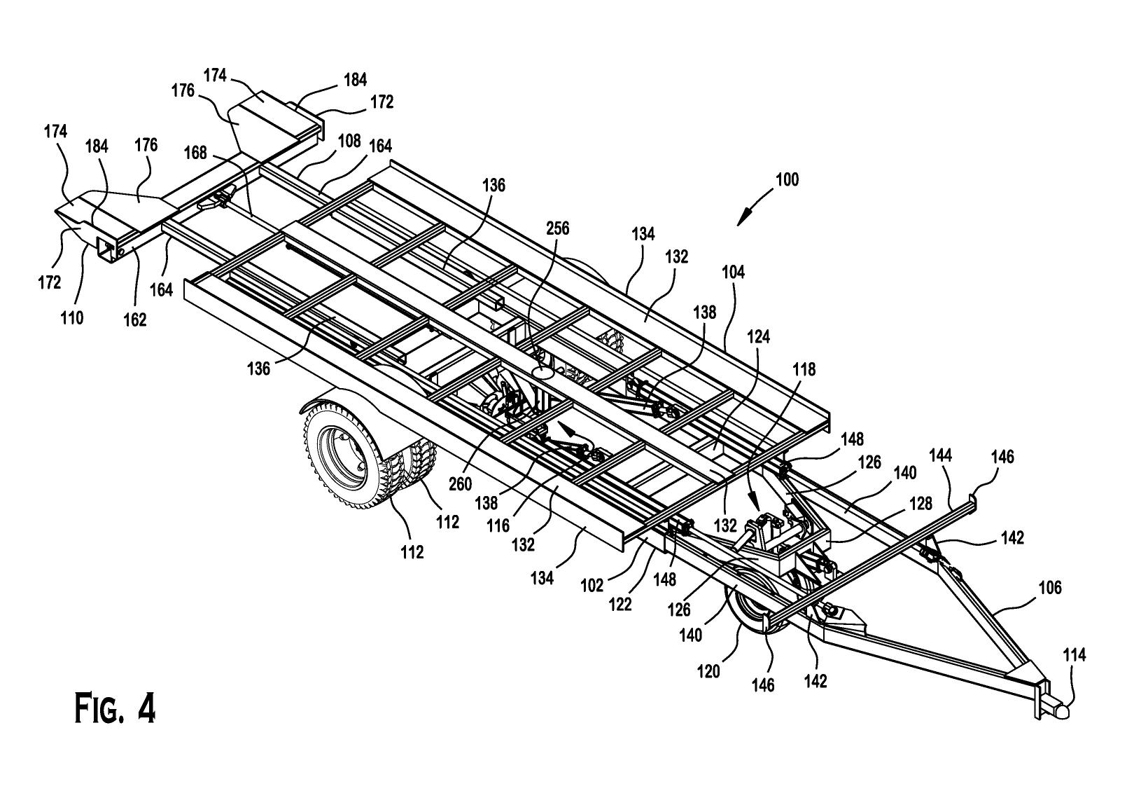

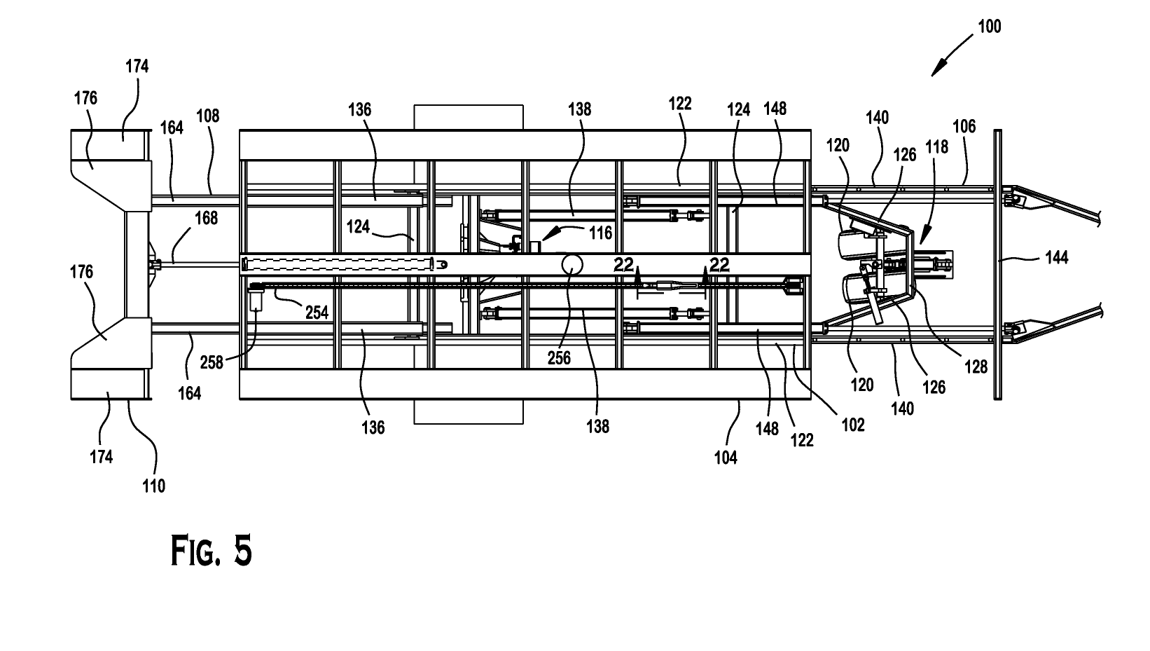

Most generally, FIGS. 1, 4, and 5 show the trailer 100 in a flat configuration where the dump frame 104 is substantially adjacent to the support frame 102. In comparison, FIGS. 2 and 3 show the trailer 100 in a dump configuration with the dump frame 104 rotated to lower a rear end of the dump frame 104 and to raise a front end of the dump frame 104. Further, FIGS. 1-3 show the trailer in a fully retracted configuration where with the extendable tongue 106 retracted fully rearward and the extendable tail 108 retracted fully forward. In comparison, FIGS. 4 and 5 show the trailer 100 in an extended configuration with the extendable tongue 106 extended forward from the support frame 102 and with the extendable tail 108 extended rearward from the support frame 102. The selective extension of the extendable tongue 106 and extendable tail 108 enable the trailer 100 to carry loads extending in length beyond the length of the dump frame 104.

The support frame 102 comprises two longitudinal tongue receivers 122 constructed, in this embodiment, of rectangular metal tubing. Tongue receivers 122 each comprise a forwardly located tongue receiver mouth that serves as an opening into the interior of the tongue receivers 122. Tongue receivers 122 are joined transversely by crossbars 124 which are constructed of similar rectangular metal tubing. Near the front of the tongue receivers 122, converging bars 126 extend inwardly and forward from the innermost exterior wall of the tongue receivers 122. The converging bars 126 do not intersect each other, but rather, they are joined by a front bar 128 which lies generally parallel with crossbars 124. Near the rear upper corners of the support frame 102, dump frame mounts 130 (see FIG. 3) extend up and rearward. Dump frame mounts 130 are substantially platelike members each comprising a mount hole for receiving components necessary to movably attach dump frame 104 to support frame 102.

The dump frame 104 comprises support beams that extend longitudinally along the length of dump frame 104. The support beams form a common support for a plurality of lateral supports, a forward bar, and a rear bar, each of which extend transverse to the support beams. Load supports 132 are longitudinal members supported by the lateral supports, the forward bar, and the rear bar. Load supports 132 are provided as a floor for supporting a load carried by the trailer 100. Sidewalls 134 extend longitudinally along the length of dump frame 104 and generally provide a protective left and right barrier for keeping a load between the sidewalls 134 as the load is carried on the trailer 100. Sidewalls 134 generally extend upward above a top surface of the load supports 132. Dump frame 104 further comprises two tail arm receivers 136 carried generally below the lateral supports and near the rear of dump frame 104. Tail arm receivers 136 are constructed of rectangular metal tubing and extend generally from the rear end of the dump frame 104 toward the front of the dump frame 104. Tail arm receivers 136 each comprise a tail arm receiver mouth which serves as an opening into the interior of the tail arm receiver 136. Dump actuators 138 are connected pivotally to support frame 102 and connected pivotally to dump frame 104 and can be controlled to pivot the dump frame 104 relative to the support frame 102 about the mount holes of the dump frame mounts 130.

The extendable tongue 106 comprises two tongue arms 140 which extend generally longitudinally and parallel to each other. Tongue arms 140 are constructed of rectangular metal tubing. The forward end of each tongue arm 140 is joined to an inward support which extends inwardly and forward so the forward ends of the inward supports are close together. The forward ends of the inward supports, together, carry the trailer coupler 114 thereat. A spacer 142 is attached to each tongue arm 140 near the front end and on the top of the tongue arms 140. The spacer 142 provides vertical support for a front load support 144 which serves and a frontward floor portion for supporting a load carried by the trailer 100. Front load support 144 extends between tongue arms 140. Discrete sidewalls 146 are provided on the left and right ends of the front load support 144 for aiding in keeping a load carried by the trailer 100 between the discrete sidewalls 146. The discrete sidewalls 146 extend above the uppermost portion of front load support 144.

The rear ends of tongue arms 140 are received into tongue receivers 122 through the tongue receiver mouths such that when extendable tongue 106 is extended, lesser portions of tongue arms 140 are housed within tongue receivers 122 than when extendable tongue 106 is retracted rearward toward the rear of support frame 102. The extension and retraction of extendable tongue 106 is accomplished through the use of tongue actuators 148. One end of each tongue actuator 148 is attached pivotally to support frame 102 while the remaining ends are pivotally attached to extendable tongue 106 through the use of support protrusions. Support protrusions are inward platelike protrusions extending generally inward from near the junctions between tongue arms 140 and the inward supports. Support protrusions each comprise an aperture suitable for pinning an end of a tongue actuator 148 thereto.

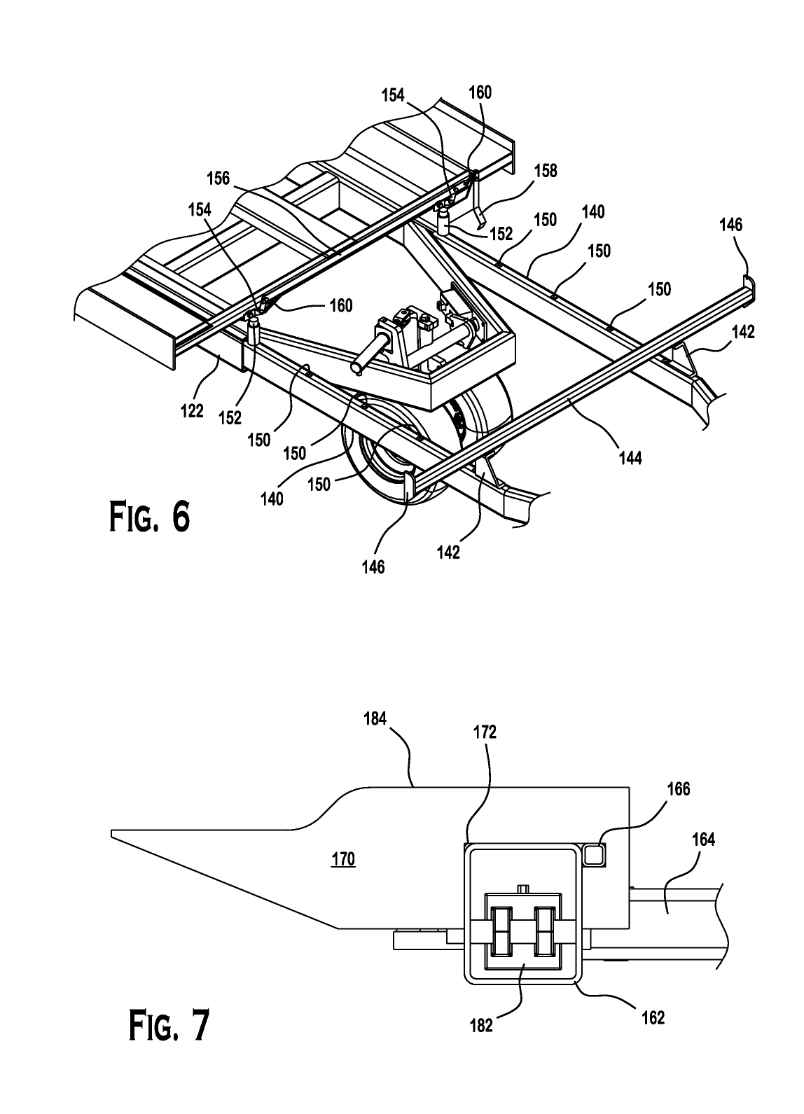

Referring now to FIG. 6, features are provided for locking the extendable tongue 106 in a selected position relative to the support frame 102. This is accomplished by providing vertically oriented through pin holes 150 for receiving pins 152 therein. The pins 152 are attached to pivotal pin arms 154 which are pivotally attached to a front portion of the support frame 102. Pin arms 154 are pivotally linked to a linkage bar 156 which extends laterally between a pin arm 154 associated with a pin 152 on the right side of the trailer 100 and a pin arm 154 associated with a pin 152 on the left side of the trailer 100. A tongue lock handle 158 is pivotally attached to a front portion of the support frame 102 and is connected to the linkage bar 156 with a tongue lock spring 160. Another tongue lock spring 160 is connected between the linkage bar 156 and the pin arm 154 near the left side of the trailer 100. By rotating the tongue lock handle 158, the linkage bar 156 is moved laterally causing the attached pin arms 154 to rotate. The rotation of the pin arms 154 causes the vertical movement of pins 152 into or out of pin holes 150, depending on the direction of rotation of tongue lock handle 158. Tongue lock springs 160 provide a self-help locking system which tends to bias the pins 152 in either an insertion direction into the pin holes 150 or in an extraction direction out of the pin holes 150. Locking the extendable tongue 106 with respect to the support frame 102 through the use of pins 152 provides proper transfer of forces between extendable tongue 106 and support frame 102 so that trailer 100 can be towed without applying improper forces to the tongue actuators 148 which also join the extendable tongue 106 and the support frame 102. However, it will be appreciated that in an alternative embodiment of the present invention, the through pin holes may be oriented substantially laterally or along a horizontal axis with respect to tongue arms 140. Horizontal pin holes may be configured so that they may receive locking pins which are similarly oriented in a lateral or horizontal manner. Of course, to use the pin holes that are laterally or horizontally oriented, the locking mechanism must be provided in such a manner to allow selective insertion and removal of the locking pins into an out of the pin holes (not shown).

Referring now to FIGS. 7-9, the extendable tail 108 comprises a tail endpiece 162 which extends laterally between the left and right sides of trailer 100. Two tail arms 164 extend forward from a forward most outer surface of tail endpiece 162. Tail endpiece 162 and tail arms 164 are constructed of rectangular metal tubing. A guide bar 166 is adjoined to the tail endpiece along an upper edge of the forward most outer surface of tail endpiece 162 such that the uppermost potion of guide bar 166 is substantially parallel with the uppermost outer surface of tail endpiece 162. Guide bar 166 is constructed of rectangular metal tubing but is smaller in cross-sectional footprint than the tail endpiece 162 to which it is attached.

The front ends of tail arms 164 are received into tail arm receivers 136 (carried by dump frame 104) through tail arm receiver mouths such that when extendable tail 108 is extended, lesser portions of tail arms 164 are housed within tail arm receivers 136 than when extendable tail 108 is retracted forward toward the rear of dump frame 104. The extension and retraction of extendable tail 108 is accomplished through the use of a tail actuator 168. One end of the tail actuator 168 is attached to dump frame 104 while the remaining end is attached to extendable tail 108 through the use of a tail protrusion. The tail protrusion is a platelike protrusion extending forward from a forward most outer wall of tail endpiece 162 substantially centered left to right along the tail endpiece 162. The tail protrusion comprises an aperture suitable for pinning an end of the tail actuator 168 thereto.

Still referring now to FIGS. 7-9, shiftable ramp 110 comprises two endplates 170 each having an endplate slot 172 where the endplates 170 are joined by a channel beam. The endplate slots 172 are formed to have a shape substantially similar to a combined cross-sectional shape of the tail endpiece 162 and adjoined guide bar 166. Therefore, the tail endpiece 162 and adjoined guide bar 166 may be passed through the slots 172 when properly aligned. Similarly, the channel beam has a lengthwise interior space which is complementary to the tail endpiece 162 and adjoined guide bar 166 so that the tail endpiece 162 and adjoined guide bar 166 may slide laterally toward the left and right sides of the trailer 100 while substantially housed within channel beam. Specifically, the channel beam comprises a lip which serves to wrap around the top, forward most, and bottom sides of the guide bar 166. Together, the channel beam and lip substantially house tail endpiece 162 and the adjoined guide bar 166 while allowing lateral movement of the tail endpiece 162 and adjoined guide bar 166 with respect to the channel beam and lip. Incline plates 174 are provided to support a trailer load and may be bent or otherwise formed to comprise a gradual inclined surface between the unbent or flat portion and the ground when the trailer 100 is in a dump configuration. Incline ramps 176 are provided which may also support a trailer load and may be bent or otherwise formed to comprise a gradual inclined surface between the unbent or flat portion and the ground when the trailer 100 is in a dump configuration. Incline ramps 176 may be shaped to be wider nearer their fronts and narrower near their rears. An inward actuator tab 178 and an outward actuator tab 180 are carried by the channel beam. The inward actuator tab 178 extends into the interior channel formed by the channel beam from a rear wall of the channel beam. The outward actuator tab 180 extends from the rear wall of the channel beam in a rearward direction and is below the incline plates 174 and incline ramps 176. The inward actuator tab 178 and outward actuator tab 180 serve as interfaces for pinning or otherwise interfacing shift actuators 182 which serve to move shiftable ramp 110 with respect to tail endpiece 162. Structural ribs are provided as substantially vertical support walls extending from incline plate. Structural ribs may be integrally formed with incline plates 174 or incline ramps 176. A rearward most wall of the channel beam comprises a setback which defines an interface between a vertically longer portion of the rearward most wall of channel beam and a vertically shorter portion of the rearward most wall of channel beam. The shorter portion of the rearward most wall of channel beam is useful in allowing desirable clearances for actuators and other hardware necessary to move shiftable ramp 110 with respect to tail endpiece 162. Endplate sidewalls 184 are provided on the left and right ends of the shiftable ramp 110 and may be formed integrally with the endplates 170. Endplate sidewalls 184 serve to keep a load carried by the trailer 100 between the endplate sidewalls 184. The endplate sidewalls 184 extend above the uppermost portions of channel beam, incline plates 174, and incline ramps 176.

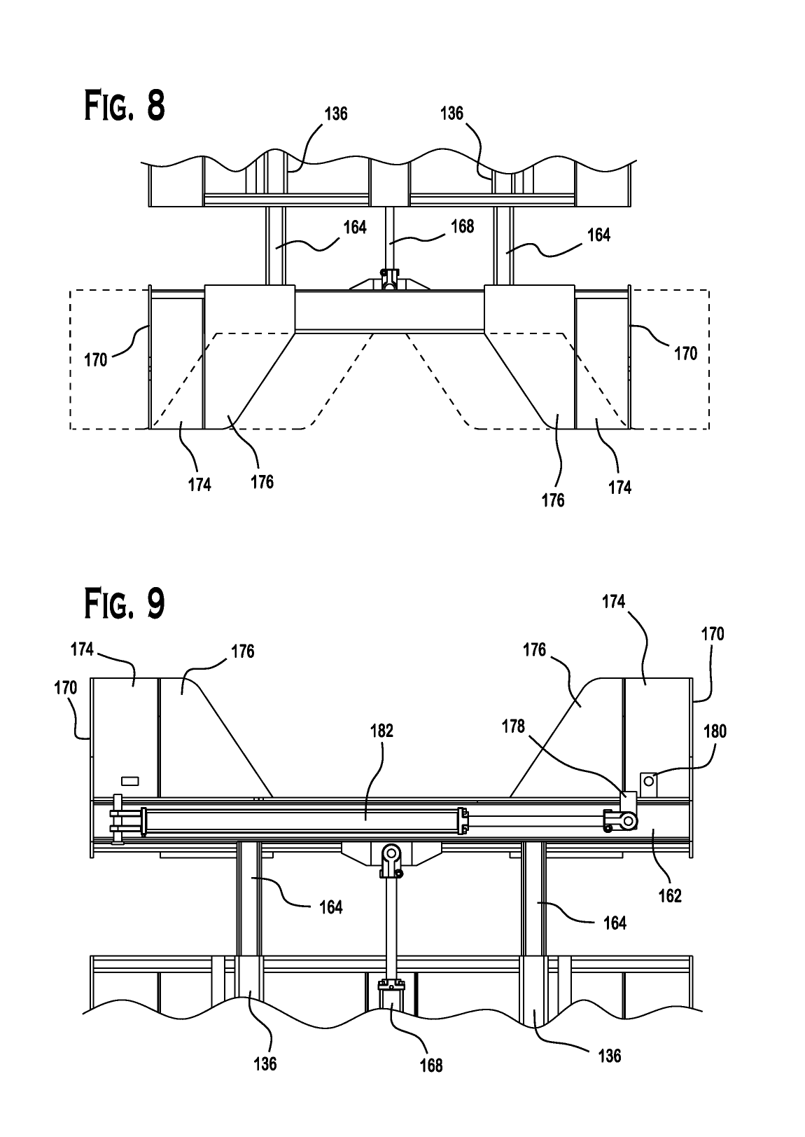

Referring now to FIGS. 8 the trailer 100 with shiftable ramp 110 in various positions (represented by phantom lines) with respect to tail endpiece 162. Shiftable tail 110 is movable laterally (toward the left and toward the right) along tail 162. Shift actuators 182 (only one shown) are connected between shiftable tail 110 and tail endpiece 162. FIGS. 1-5 and 9 illustrate shiftable tail 110 in a substantially centered position where the left and right ends of shiftable tail 110 are substantially aligned with the left and right side of the remainder of the trailer 100 and where the endplate sidewalls 184 are substantially aligned with sidewalls 134.

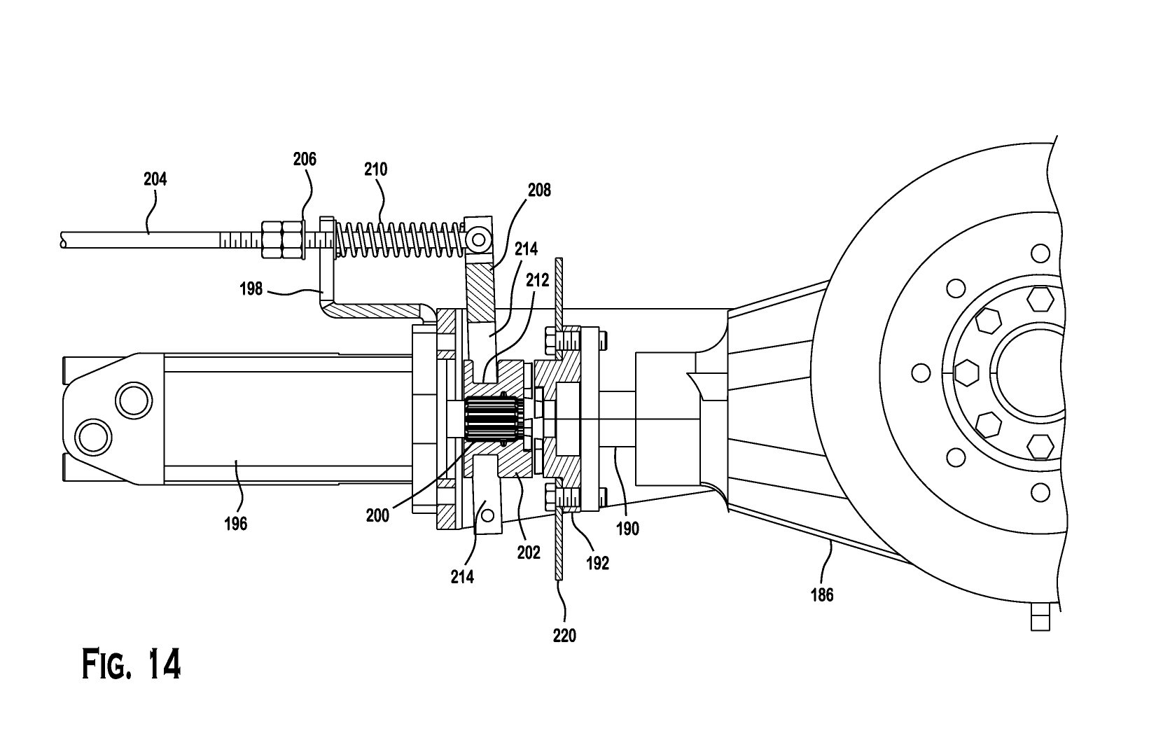

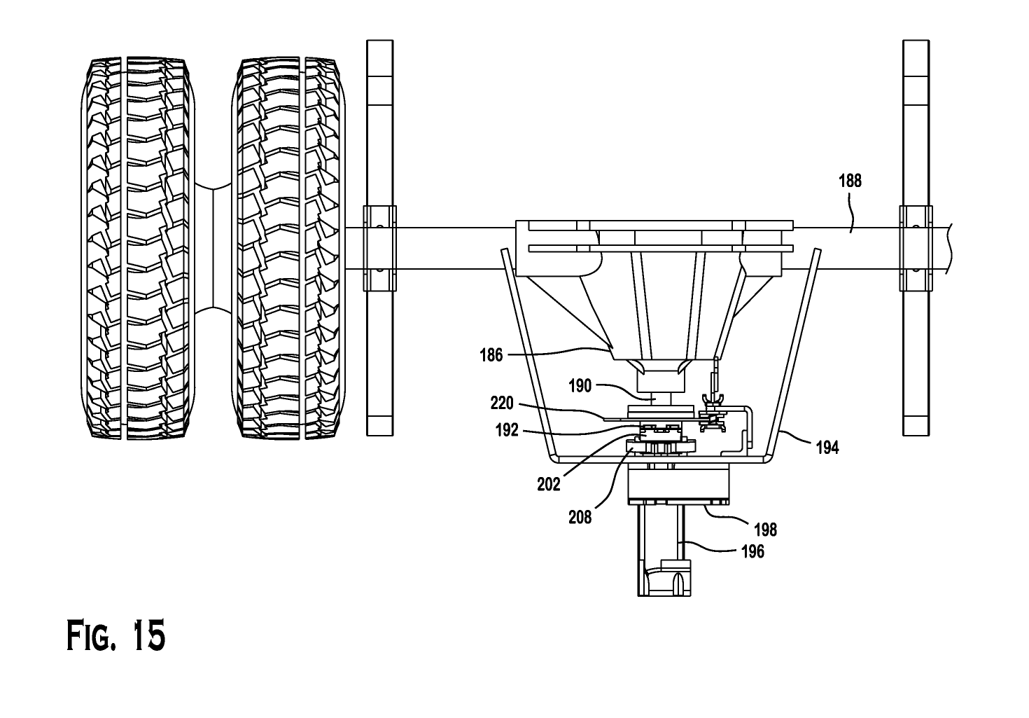

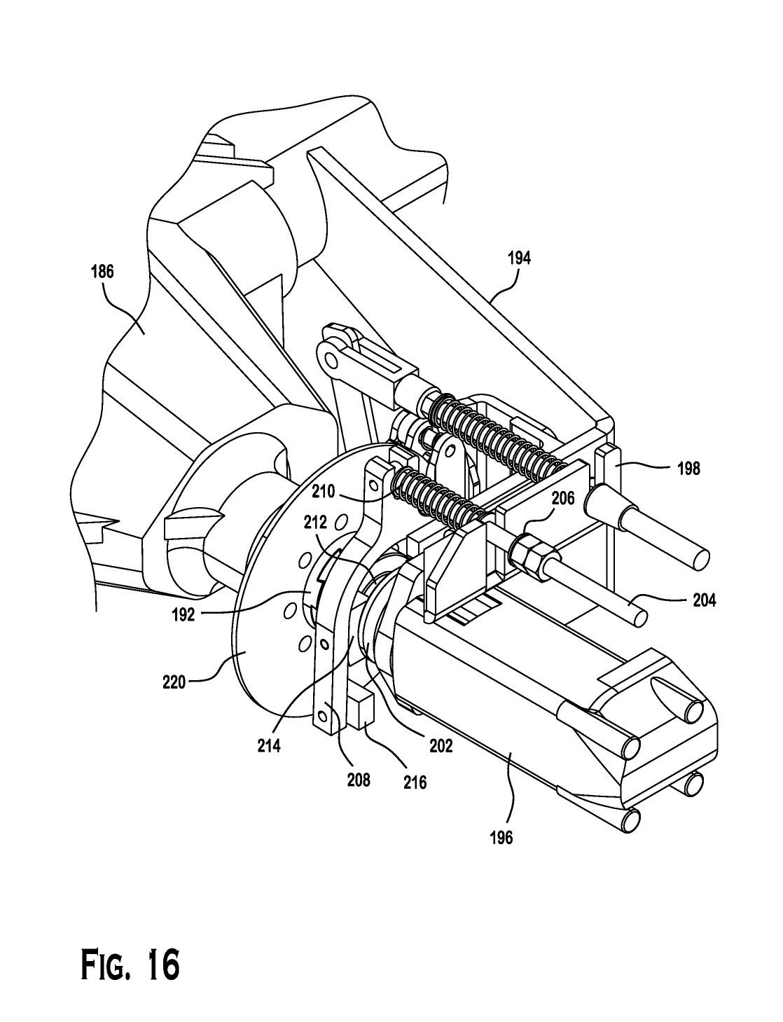

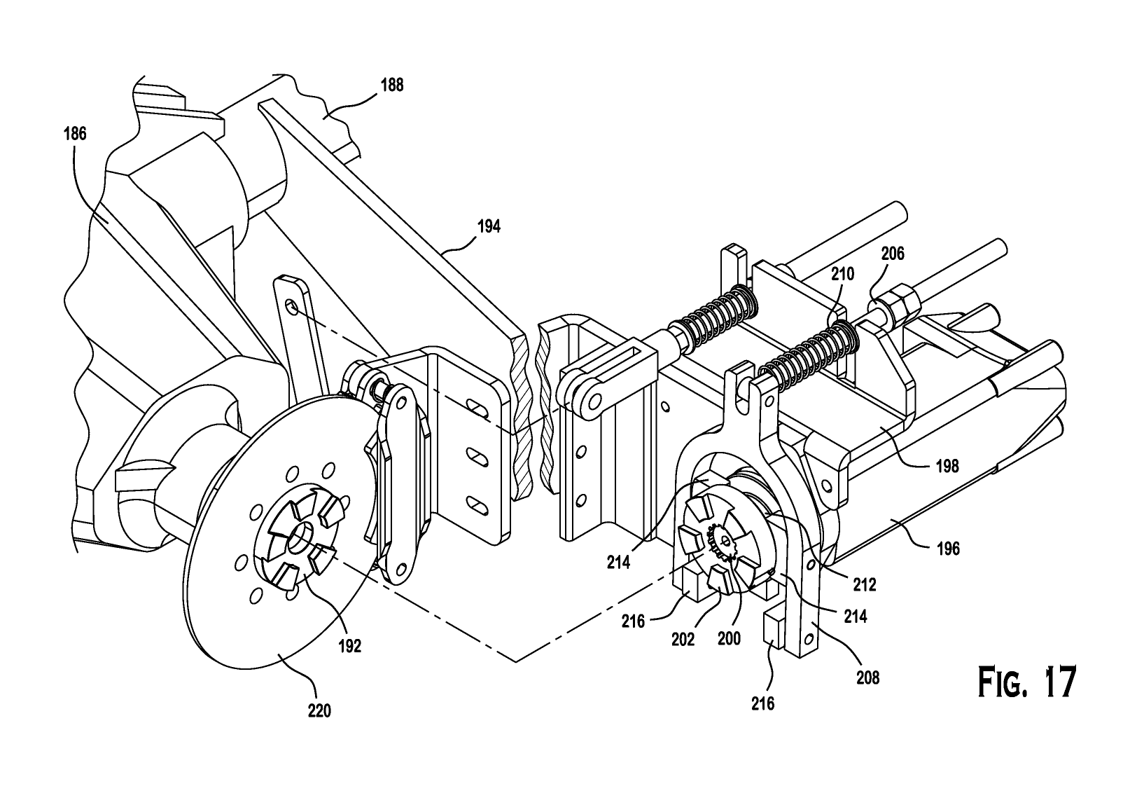

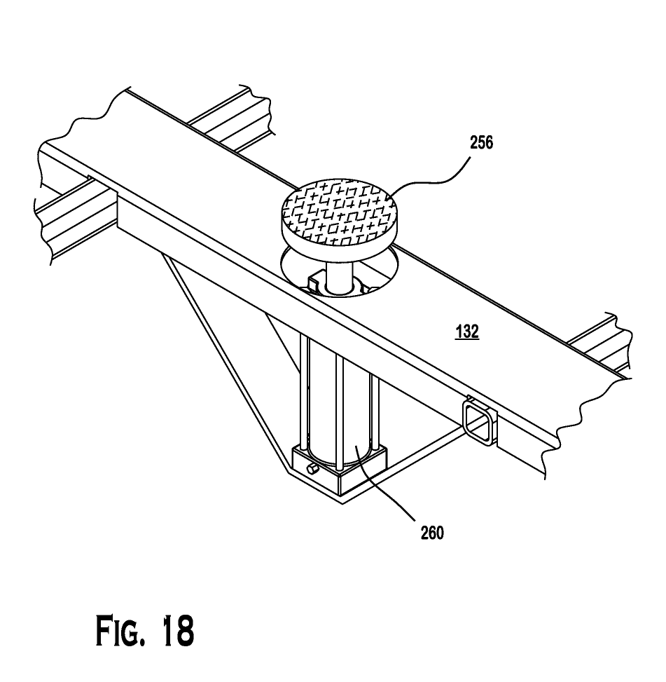

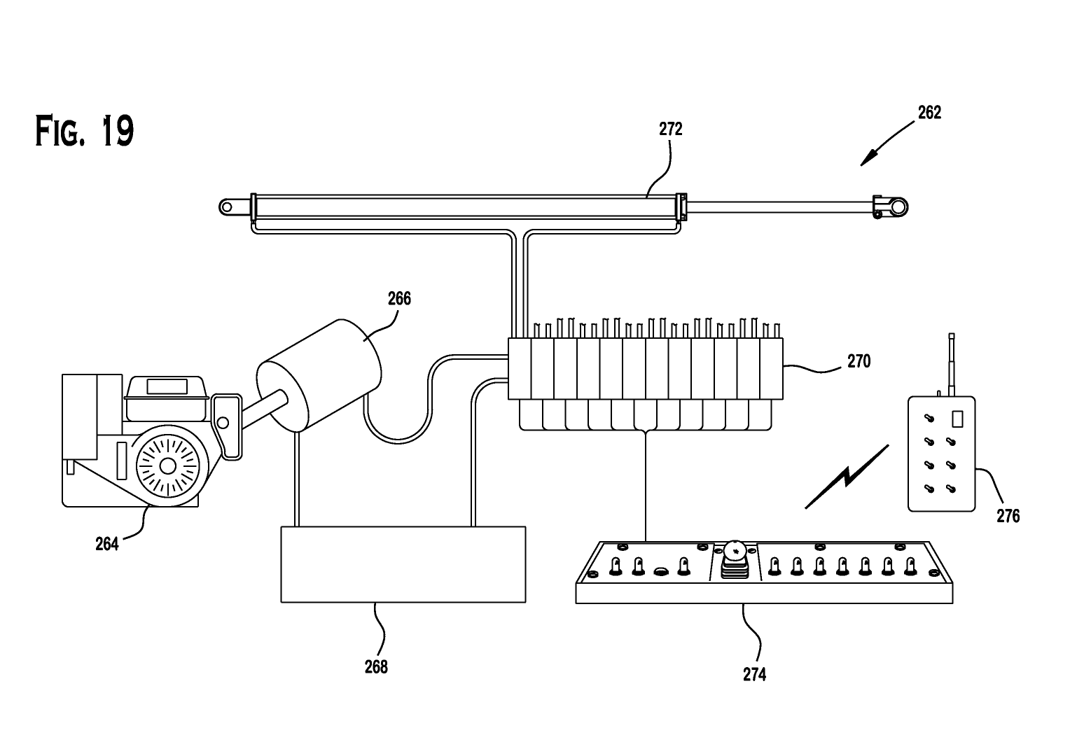

Referring now to FIGS. 14-17 the drive system 116 is shown. Drive system 116 comprises a drive transmission 186 attached to drive axle 188. A transmission shaft 190 having a transmission gear 192 with engaging teeth generally facing the front of the trailer 100. A generally U-shaped drive system support 194 is attached to the axle 188 so that a the support 194 is suitable for supporting a hydraulic drive motor 196 on a front side of the drive system support 194. A slotted stop 198 is also carried by the front side of the drive system support 194. The drive motor 196 is oriented such that a motor shaft 200 (see FIG. 14) extends through a hole in the drive system support 194 toward the rear of the trailer 100. The motor shaft 200 is adapted to have a spline feature for interfacing with a motor gear 202 (discussed infra). A threaded rod 204 extends longitudinally through a slot in slotted stop 198 and has a rod stop 206. Threaded rod 204 is movable lengthwise with respect to the rod stop 206 and the rod stop 206 serves to limit the rearward movement of threaded rod 204 with respect to slotted stop 206. Threaded rod 204 is pinned to a portion of a substantially wishbone shaped fork 208 near an uppermost portion of the fork 208 so that longitudinal movement of the threaded rod 204 causes movement of the fork 208. A rod spring 210 is carried by threaded rod 204 and is located between slotted stop 198 and fork 208 so that the uppermost portion of the fork 208 is biased away from the slotted stop 198. Motor gear 202 is adapted for sliding engagement with the spline motor shaft 200. Motor gear 202 comprises an annular recessed collar 212 for allowing fork collar blocks 214 (which are pivotally pinned to central portions of the opposing legs of fork 208) to push and pull motor gear 202 along the spline motor shaft 200 toward and away from transmission gear 192. This pushing and pulling of motor gear 202 along the spline motor shaft 200 allows for selective engagement and disengagement between motor gear 202 and transmission gear 192. Fork mount blocks 216 are pinned near to the lower portions of the opposing legs of fork 208 and space the opposing legs of fork 208 from slotted stop 198. The combination of the threaded rod 204 being pinned to the upper portion of fork 208, the collar blocks 214 being pinned to central portions of the opposing legs of fork 208, and fork mount blocks 216 being pinned to the lower portions of the opposing legs of fork 208 provide for linear displacement of motor gear 202 without binding.

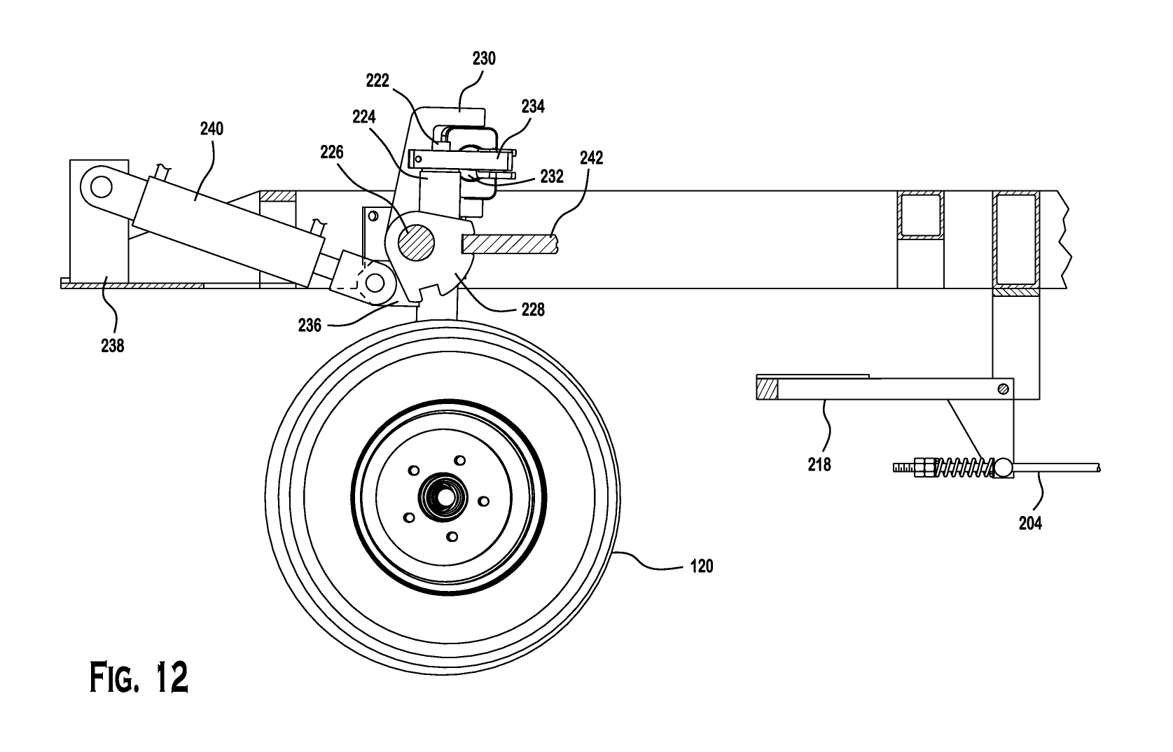

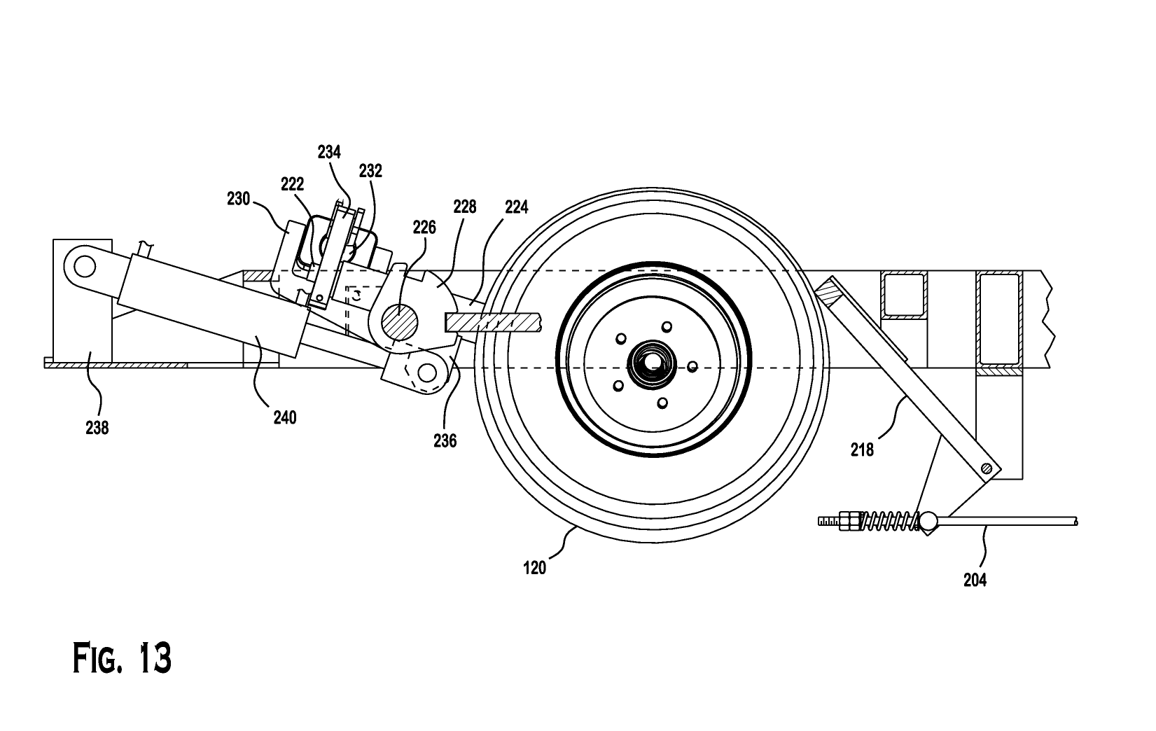

Referring now to FIGS. 12 and 13, an engagement lever 218 is shown. Engagement lever 218 is pivotally attached to the support frame 102 and is associated with threaded rod 204 such that vertical displacement of a forwardmost end of engagement lever 218 causes longitudinal displacement of threaded rod 204. Therefore, vertical displacement of engagement lever 218 results in selective engagement and disengagement of motor gear 202 and transmission gear 192 due to fork 208 movement as described above. In the embodiment shown, engagement lever 218 is located so that retraction and deployment of steering system 118 causes the steering wheels 120 to vertically displace the engagement lever 218 in a manner intended to cause engagement and disengagement of the motor gear 202 and transmission gear 192.

Again referring to FIGS. 14-17 a caliper brake assembly having a brake rotor 220 is illustrated. Brake rotor 220 is mounted to transmission shaft 190 behind transmission gear 192. The caliper brake assembly is mounted to drive system support 194 through the use of a caliper mount. A brake line having an integral stop is associated with slotted stop along with a brake spring for biasing the brake system. The brake line is pinned to the brake lever so that extension or retraction of the brake line selectively causes a squeezing movement of caliper brake assembly so that brake pads of the caliper brake assembly contact brake rotor, thereby selectively impeding rotation of the transmission shaft 190.

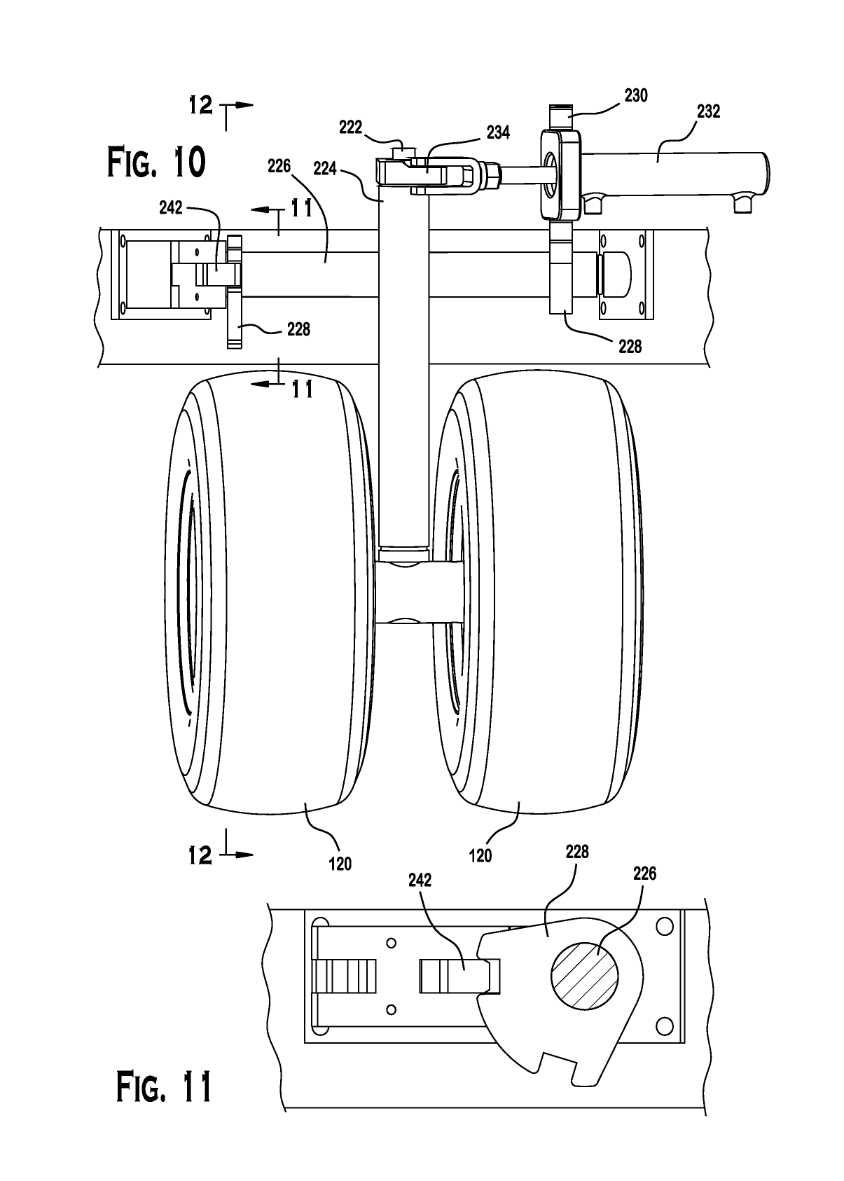

Referring now to FIGS. 10-13, the steering system 118 is illustrated. FIGS. 10-12 show the steering system 118 in a deployed, lowered, or operable position where steering wheels 120 are in contact with the ground or support surface. FIG. 13 illustrates the same embodiment of steering system 118 in a retracted, raised, or inoperable position where steering wheels 120 are substantially removed from the ground or support surface. Steering system 118 comprises a steering axle common to both steering wheels 120. The steering axle is joined to a steering shaft 222 of a steering column 224. The steering shaft 222 is rotatable within the steering column 224 to allow angular displacement of the steering axle and of steering wheels 120 upon the application of angular force to an upper end of the steering shaft 222. The steering column 224 is attached to a column support bar 226 which extends generally laterally between converging bars 126 of support frame 102. Substantially flat mounting pads are attached to the ends of column support bar 226 to allow mounting of column support bar 226 to converging bars 126. Column support bar 226 is rotatable about its central axis converging bars 126. Column support bar 226 comprises a slotted angular protrusion 228 which is fixed to column support bar 226 near the right end of column support bar 226 such that the slotted portion of slotted angular protrusion 228 is open angularly outward away from column support bar 226 and such that the slotted portion rotates angularly with rotation of column support bar 226. Column support bar 226 also comprises an attached steering actuator mount 230 which is configured to carry a steering actuator 232. Steering actuator 232 is connected to the steering actuator mount 230 and pinned to an adjustable steering lever 234. Adjustable steering lever 234 is connected to steering shaft 222 and serves to rotate steering shaft 222 upon actuation of steering actuator 232. A retraction column mount 236 protrudes from steering column 224 toward the front of trailer 100. A retraction actuator mount 238 is connected to a front wall of front bar 128 of support frame 102. A retraction actuator 240 is connected to and carried by the retraction actuator mount 238 and is pinned to the retraction column mount 236 so that actuation of retraction actuator 240 causes rotation of column support bar 226. This rotation is responsible for moving the steering system 118 between the deployed, lowered, or operable position where steering wheels 120 are in contact with the ground or support surface and the retracted, raised, or inoperable position where steering wheels 120 are substantially removed from the ground or support surface. When the steering system 118 is retracted, the front of the trailer 100 may be supported by a jack stand (not shown) or by a towing vehicle (not shown). A biased locking finger 242 is employed to engage slotted angular protrusion 228 in a manner which locks steering system 118 in the retracted position. The biased locking finger 242 is controlled by a locking finger actuator (not shown) that can actuate the biased locking finger 242. The slotted angular protrusion 228 may have multiple slotted portions allowing for locking the steering system 118 in different degrees of angular displacement about the central axis of column support bar 226. The biased locking finger 242 is mounted on a mounting pad and is located to the rear of slotted angular protrusion 228.

FIG. 3 illustrates a stabilizer 244 mounted to trailer 100 near the rear right side corner of the trailer 100 for providing optional supplemental support to the trailer support frame 102. Stabilizer 244 is connected to a stabilizer leg mount 246 which extends down from the support frame 102. One end of a leg 248 of the stabilizer 244 is pinned to the stabilizer leg mount 246 at a lower point along the stabilizer leg mount 246. One end of a stabilizer actuator 250 is pinned to an upper point along the stabilizer leg mount 246, higher than the connection between the leg 248 and the stabilizer leg mount 246. The remaining end of the stabilizer actuator 250 is pinned near the remaining end of the leg 248. A substantially flat foot 252 is pinned to the distal end of the leg 248 providing a broader interface with the ground or support surface when the stabilizer actuator 250 is actuated to cause pivoting of the leg 248 to the ground or support surface.

FIG. 1-5 and illustrate a chain drive 254 (FIG. 5 only) and a load spinner 256. The chain drive 254 is a roller chain oriented lengthwise with the trailer 100 and housed substantially in an open top chain channel for keeping the chain from straying left and right. Near the front of the trailer 100, the chain drive 254 is looped over a free gear which is rotatably supported between two pillow blocks. Near the rear of the trailer, the chain drive 254 is looped over a chain drive gear which is driven by a chain drive motor 258. By operating the chain drive motor 258, the chain drive 254 can be driven. Through the use of a removable attachment having a hook and an angularly spring biased upper wall, loads can more easily be dragged and or carried onto and off of trailer 100. The load spinner 256 is a rotatable and vertically displaceable plate for lifting and thereafter spinning a load which is carried atop trailer 100. This spinning action aids in orienting a load as needed for placement at a delivery site and for adjusting the load with relation to the trailer 100. Load spinner 256 is connected to a load spinner actuator 260. When load spinner 256 is fully retracted downward, a top surface of load spinner 256 is located generally below the plane shared by the upper surfaces of load supports 132. When load spinner 256 is fully extended upward, the top surface of load spinner 256 is located substantially above the plane shared by the upper surfaces of load supports 132. When a load is supported solely by load spinner 256, the load can easily be rotated with load spinner 256 about the longitudinal axis of a retractable shaft of the load spinner actuator 260. Load spinner corrugations are provided on the upper surface of load spinner 256 to decrease slipping between the load spinner 256 and a load supported by the load spinner 256.

Referring now to FIG. 3, a storage compartment 261 is illustrated as being located on the right side of the trailer 100. Storage compartment 261 is substantially a box-like structure comprising a securable door.

Referring now to FIG. 19, a schematic diagram of a control system 262 of the mechanically actuated functionality of the present invention is illustrated. In this embodiment, the control system 262 comprises a power plant 264 that may be a gasoline powered engine or generator, a hydraulic pump 266 for providing hydraulic pressure to actuators, a hydraulic fluid reservoir 268 for housing hydraulic fluid, an electrically operated hydraulic distribution manifold 270 for selectively passing fluid to various hydraulic actuators 272. The control system 262 further comprises a hard wired electrical control panel 274 comprising buttons, switches, and joysticks for the purpose of selectively directing fluid through the manifold 270. The control system 262 further comprises a wireless remote control 276 comprising switches and buttons for the purpose of selectively directing fluid through the manifold 270. With the exception of the wireless remote control 276, the various components of the control system 262 are carried by the trailer 100.

Using the control system 262, all of the various functions of the trailer 100 may be controlled. Specifically, the trailer 100 may be controlled to move in a controlled and steered manner under its own power generated by the power plant 264. Further, all of the various motors and actuators of the present invention are controlled using the control system 262.

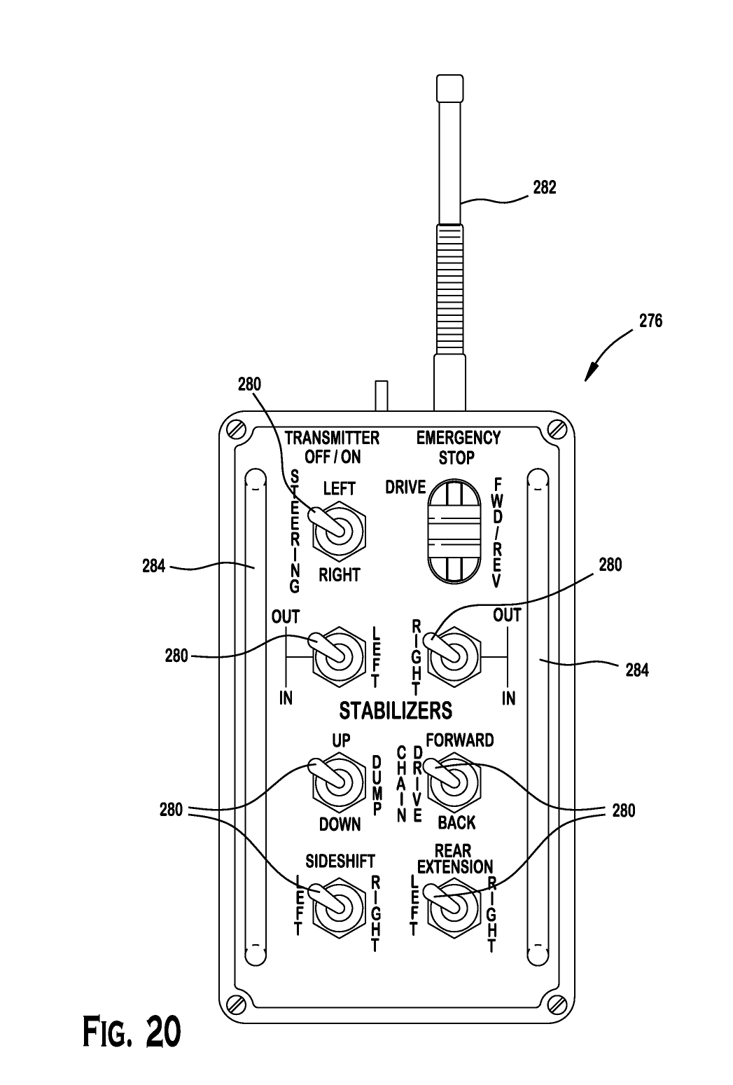

Referring now to FIG. 20, the remote control 276 is illustrated which similarly comprises the necessary buttons, switches, joysticks and other control devices necessary to command the various actuators of trailer 100. Specifically, the remote control 276 comprises switches for turning the remote control 276 on and off, steering the trailer 100, moving the dump frame 104 between a horizontal orientation and a dump orientation, extending and retracting the left and right stabilizers 244, driving the chain drive motor 258 forward and backward, shifting the shiftable ramp 110 left and right, extending and retracting the extendable tail 108, and an emergency stop switch for disabling all powered systems. The remote control 276 comprises a box-like case 278 for housing the electronics and for mounting switches 280 thereto. An antenna 282 is also mounted to the case 278. Further, to prevent inadvertent switching of the emergency stop switch, a flip open safety cover may be incorporated. Finally, protective face bars 284 are incorporated to prevent inadvertent switching and damage due to dropping the remote control 276 on the face which comprises the above described switches 280.

Trailer 100 may optionally further comprises components such as lights, towing safety chains, a conventional trailer brake system, wheel well covers, a power plant, hydraulic system, pumps, cylinders, valves, liquid reservoirs, liquid manifolds, hoses, connectors, bearings, batteries, load tie down devices as suitable and complementary to the above describe features of trailer 100. Some of these devices may be illustrated but not labeled for the sake of clarity.

The foregoing illustrates some of the possibilities for practicing the invention. Many other embodiments are possible within the scope and spirit of the invention.

What is claimed is:

1. A trailer, comprising:
a support frame supported by at least two drive wheels;
a drive system configured to selectively rotate the at least two drive wheels;
a dump frame associated with the support frame and pivotable with respect to the support frame;
a steering system comprising at least one steerable wheel located forward of the at least two drive wheels; and
an extendable tail carried by the dump frame, the extendable tail being selectively extendable from a rear of the dump frame.

2. The trailer according to claim 1, further comprising:
a shiftable ramp carried by the extendable tail, the shiftable ramp being selectively movable laterally with respect to the extendable tail.

3. The trailer according to claim 1, further comprising:
an extendable tongue carried by the support frame, the extendable tongue being selectively extendable from a front of the support frame.

4. The trailer according to claim 3, further comprising:
a movable pin carried by the dump frame, the pin being selectively insertable into a pin hole of the extendable tongue for securing the extendable tongue with respect to the support frame.

5. The trailer according to claim 1, further comprising:
a rotatable column support bar supported between converging bars of the support frame;
wherein the at least one steerable wheel is carried by the column support bar and the at least one steerable wheel is movable between a retracted position and a lowered position by rotating the column support bar.

6. The trailer according to claim 5, further comprising:
a slotted angular protrusion carried by the column support bar; and
a biased locking finger configured to selectively engage a slot of the slotted angular protrusion.

7. The trailer according to claim 6, wherein engaging the biased locking finger with the slot of the slotted angular protrusion locks the column support bar in a retracted position where the at least one steerable wheel is removed from a support surface.

8. The trailer according to claim 5, further comprising:
an engagement lever carried by the support frame;
wherein positioning the steerable wheel in the retracted position moves the engagement lever and thereby causes the drive system to be disabled.

9. The trailer according to claim 1, further comprising:
a stabilizer carried by the support frame; and
a stabilizer actuator configured to selectively move the stabilizer with respect to the support frame.

10. The trailer according to claim 1, further comprising:
a hydraulic drive motor for driving the at least two drive wheels.

11. The trailer according to claim 10, the hydraulic drive motor comprising:
a splined motor shaft.

12. The trailer according to claim 11, further comprising:
a motor gear configured for engagement with the splined motor shaft and selectively engageable with a drive transmission.

13. The trailer according to claim 12, wherein the motor gear is engaged with the drive transmission when the steerable wheel is in a retracted position.

14. The trailer according to claim 1, further comprising:
a load spinner carried by the dump frame, the load spinner having a selectively retractable plate movable between a position above a load support of the dump frame and a position below the load support.

15. The trailer according to claim 14, further comprising:
a load spinner actuator for selectively moving the retractable plate between the position above the load support of the dump frame and the position below the load support;
wherein the retractable plate is rotatable about an axis of a shaft of the load spinner actuator.

16. The trailer according to claim 1, further comprising:
a chain drive carried by the dump frame, the chain drive selectively moving with respect to the dump frame.

17. The trailer according to claim 1, further comprising:
a control system having a power plant, a hydraulic pump, and a control panel for controlling at least one of the drive system, the dump frame, and the steering system.

18. The trailer according to claim 17, the control system further comprising:
a wireless remote control.

19. The trailer according to claim 1, further comprising:
a shiftable ramp carried by the extendable tail, the shiftable ramp being selectively movable laterally with respect to the extendable tail; and
an extendable tongue carried by the support frame, the extendable tongue being selectively extendable from a front of the support frame.

20. A trailer, comprising:
a support frame supported by at least two drive wheels;
a drive system configured to selectively rotate the at least two drive wheels;
a steering system carried on the support frame, the steering system comprising at least one steerable wheel located forward of the at least two drive wheels; and
an extendable tongue carried by the support frame, the extendable tongue being selectively extendable from a front of the support frame.
